(19) United States
(12) Patent Application Publication
(10) Pub. No.: US 2022/0011607 A1
(43) Pub. Date: Jan. 13, 2022

(54) VIEWING ANGLE ADJUSTMENTS

(71) Applicant: Hewlett-Packard Development Company, L.P., Spring, TX (US)

(72) Inventors: Hsing-Hung Hsieh, Taipei City (TW); Alan Man Pan Tam, Spring, TX (US); Dehuei Chen, Taipei City (TW)

(73) Assignee: Hewlett-Packard Development Company, L.P., Spring, TX (US)

(21) Appl. No.: 17/293,666

(22) PCT Filed: Jan. 10, 2019
(86) PCT No.: PCT/US2019/012997

§ 371 Date: May 13, 2021

(51) Int. Cl. G02F 1/13; G02F 1/13357; G02F 1/1343; G02F 1/1334

(52) U.S. Cl. CPC G02F 1/1323; G02F 1/1334; G02F 1/134309; G02F 1/133602

(57) ABSTRACT

Example electronic devices including a display are disclosed. In an example, the display includes a backlight, and an image generator to form an image from light emitted from the backlight. In addition, the display includes a first privacy panel and a second privacy panel disposed between the backlight and the image generator. The first privacy panel includes a first set of parallel lines, and the second privacy panel includes a second set of parallel lines that are perpendicular to the first set of parallel lines. The first set of parallel lines is to actuate to selectively adjust a first viewing angle of the display in a first plane, and the second set of parallel lines is to actuate to selectively adjust a second viewing angle of the display in a second plane that is perpendicular to the first plane.

### BACKGROUND

Electronic displays are used in a variety of different ways and in a variety of different types of devices. For example, such displays are the primary component of devices such as televisions and computer monitors, and are integrally formed within other computing devices such as, for example, laptop computers, tablet computers, all-in-one computers, smartphones, etc. The images and/or information projected by a display may include, for example, data, documents, textural information, communications, motion pictures, still images, etc. (all of these examples may be collectively referred to herein as “images”).

### BRIEF DESCRIPTION OF THE DRAWINGS

Various examples will be described below referring to the following figures:

FIG. 1 is a front view of an electronic device including a display according to some examples;

FIG. 2 is a side view of the electronic device of FIG. 1 according to some examples;

FIG. 3 is a schematic cross-sectional view of the display of the display of the electronic device of FIG. 1 according to some examples;

FIG. 4 is a schematic cross-sectional view of a first privacy panel of the display of the electronic device of FIG. 1 according to some examples;

FIG. 5 is a schematic cross-sectional view of a second privacy panel of the display of the electronic device of FIG. 1 according to some examples;

FIG. 6 is a top view of the privacy panel of FIG. 4 according to some examples;

FIG. 7 is a top view of the privacy panel of FIG. 5 according to some examples;

FIG. 8 is a schematic cross-sectional view of the first privacy panel of the display of FIG. 3 with a first set of parallel lines of the first privacy panel in a transparent state according to some examples;

FIG. 9 is a schematic cross-sectional view of the first privacy panel of the display of FIG. 3 with the first set of parallel lines in a non-transparent state according to some examples;

FIG. 10 is a schematic cross-sectional view of a display that may be used within the electronic device of FIG. 1 according to some examples;

FIG. 11 is a front view of another electronic device including an display and disposed in a first orientation according to some examples;

FIG. 12 is a front view of the electronic device of FIG. 11 in a second orientation according to some examples;

FIG. 13 is a schematic diagram of the electronic device of FIG. 11 according to some examples; and

FIG. 14 is a flow chart of a method for selectively adjusting a viewing angle of a display in a pair of perpendicular planes according to some examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . ” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “radial” and “radially” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein (including in the claims), the words “generally,” “about,” or “substantially” mean within a range of plus or minus 20% of the stated value. As used herein, the term “electronic display” refers to a device that emits light to display an image. As used herein, the term “electronic device” refers to any device or assembly that operates by utilizing electrical current and that includes, or is coupled to, an electronic display. Specifically, the term “electronic device,” includes “computing devices” which may be any suitable device that may execute, generate, or store machine readable instructions. Example computing devices include, for instance, desk top computers, lap top computers, tablet computers, smart phones, etc. As used herein, the term “refractive index” of a specified medium refers to the ratio of the velocity of light in a vacuum to the velocity of light through the specified medium.

As previously described above, electronic displays (or more simply “displays”) are utilized to project images and/or information (which is collectively referred to herein as “images”) for viewing by a user or plurality of users. In some instances, displays are used to project images that are considered confidential or sensitive. Thus, the intended or authorized viewer of the display may wish to limit the visibility of the images on the display to a select viewing position or positions relative to the display. Accordingly, examples disclosed herein include electronic displays that are to selectively restrict the visibility of the images projected thereby to a preselected viewing position or number of viewing positions.

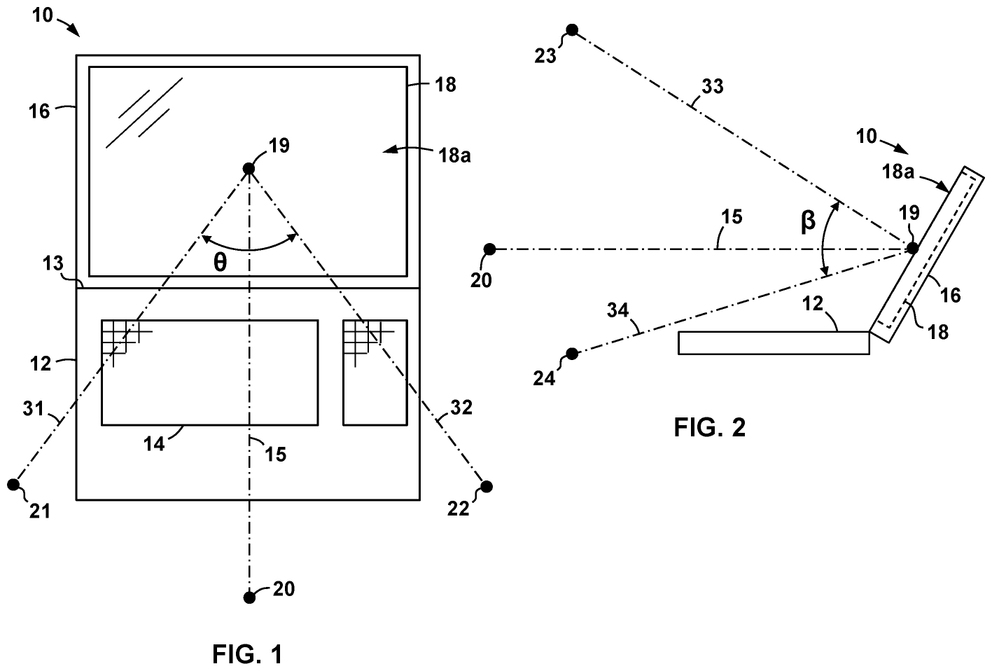

Referring now to FIG. 1, an electronic device 10 according to some examples is shown. In this example, electronic device 10 is a laptop computer that includes a first housing member 12 rotatably coupled to a second housing member 16 at a hinge 13. The first housing member 12 includes a user input device, such as, for example, a keyboard 14. The second housing member 16 includes an electronic display 18 (or more simply “display 18”) that is to project images out of a front side 18a for viewing by a user (not shown) of the electronic device 10.

Referring now to FIGS. 1 and 2, a user may typically be positioned in front of the display 18 of electronic device 10 at a position 20. Position 20 may be disposed at or near a “zero-axis” position relative to display 18 so that position 20 is directly in front of display 18 (or nearly directly in front). In particular, position 20 may be disposed along an axis 15 that extends outward from a center 19 of display 18. Axis 15 may extend perpendicularly from the lateral span of display 18. Thus, position 20 may be referred to herein as front viewing position.

Display 18 may be viewable from other positions other than the front viewing position 20, such as viewing positions that are laterally and/or vertically shifted from the front viewing position 20. Therefore, display 18 defines a first viewing angle θ, and a second viewing angle β that extends perpendicular to the first viewing angle θ. Because first housing member 12 of electronic device 10 is typically placed flat on a laterally oriented support surface (e.g., table, desk, etc.), the first viewing angle θ may be referred to herein as a “lateral viewing angle θ” and the second viewing angle β may be referred to herein as a “vertical viewing angle β,” In the context of electronic device 10.

As best shown in FIG. 1, the lateral viewing angle θ may extend between a pair of off-axis viewing positions 21, 22 that are laterally shifted from the front viewing position 20. Off-axis viewing positions 21, 22 represent the most extreme positions to the left and right, respectively, from the display 18 from which a viewer may still see or discern the images projected therefrom. Viewing positions that are shifted laterally outside or beyond the positions 21, 22 may represent positions from which a viewer may no longer see or discern the images projected by display 18. Each viewing position 21, 22 may have a line of sight or axis 31, 32, respectively, extending between the positions 21, 22, respectively, and the center 19 of display 18. Together, the axes 15, 31, 32 define a first plane, and the first viewing angle θ extends within this plane between the axes 31, 32. Because first housing member 12 is typically disposed on a lateral support surface during operations as previously described, the first plane defined by axes 15, 31, 32 may be a lateral plane.

As best shown in FIG. 2, the vertical viewing angle β may extend between a pair of off-axis viewing positions 23, 24 that are vertically shifted from the front viewing position 20. Off-axis viewing positions 23, 24 represent the most extreme positions above and below, respectively, from the display 18 from which a viewer may still see or discern the image projected therefrom. Viewing positions that are shifted vertically outside or beyond the positions 23, 24 may represent positions from which a viewer may no longer see or discern the images projected by display 18. Each viewing position 23, 24 may have a line of sight or axis 33, 34, respectively, extending between the positions 23, 24, respectively, and the center 19 of display 18. Together, the axes 15, 33, 34 define a second plane, and the second viewing angle β extends within this plane between the axes 33, 34. As can be appreciated from FIGS. 1 and 2, the second plane defined by axes 15, 33, 34 is perpendicular to the first plane defined by axes 15, 31, 32. In addition, because first housing member 12 is typically disposed on a lateral support surface during operations as previously described, the second plane defined by axes 15, 33, 34 may be a vertically oriented plane.

As will be described in more detail below, display 18 includes a pair of privacy panels (not shown in FIGS. 1 and 2) that are to selectively adjust or limit the viewing angles θ, β of display 18 so as to provide selective privacy from off-axis viewers that are vertically and/or laterally adjacent to the front viewing position 20. This function and specific example structures of display 18 will now be described in more detail below.

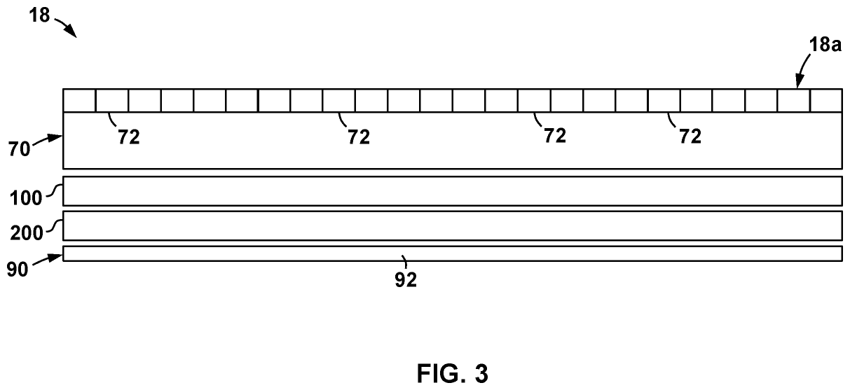

Referring now to FIG. 3, an example of display 18 for use within electronic device 10 of FIGS. 1 and 2 is shown. Generally speaking, display 18 includes an image generator 70, a backlight 90, a first privacy panel 100, and a second privacy panel 200. The first privacy panel 100 and the second privacy panel 200 are disposed between the image generator 70 and the backlight 90.

Generally speaking, image generator 70 is to form an image from the light emitted from backlight 90, and thus may include a display panel and a controller (or other circuitry) to control operation of the display panel. In this particular example image generator 70 includes a plurality of pixels 72 arranged in a plurality of columns and rows. Pixels 72 are a defined area of illumination on display 18, and in some examples may comprise colored sub-pixels such as those found within a color display. During operations, pixels 72 are selectively illuminated by display 18 (particularly by the display panel of image generator 70) so as to project an image out of front side 18a of display 18.

Image generator 70 may use any suitable display technology to generate and project the image via pixels 72. For instance, image generator 70 may comprise a liquid crystal display panel, a plasma display panel, etc. The specific components of image generator 70 that facilitate the selective illumination of pixels 72 is not shown in FIG. 3 in order to simply the figure and following discussion.

Backlight 90 includes a light source 92 that is to generate light for transmission through the other components of display 18 and out of front side 18a during operations. Any suitable source of light may be used within light source 92 such as, for example, light emitting diodes (LED), incandescent bulbs, fluorescent lighting etc. In addition, while not specifically shown, in some examples, backlight 90 may include a light guide or other suitable device for directing the light emitted from light source 92 toward front side 18a of the display 18.

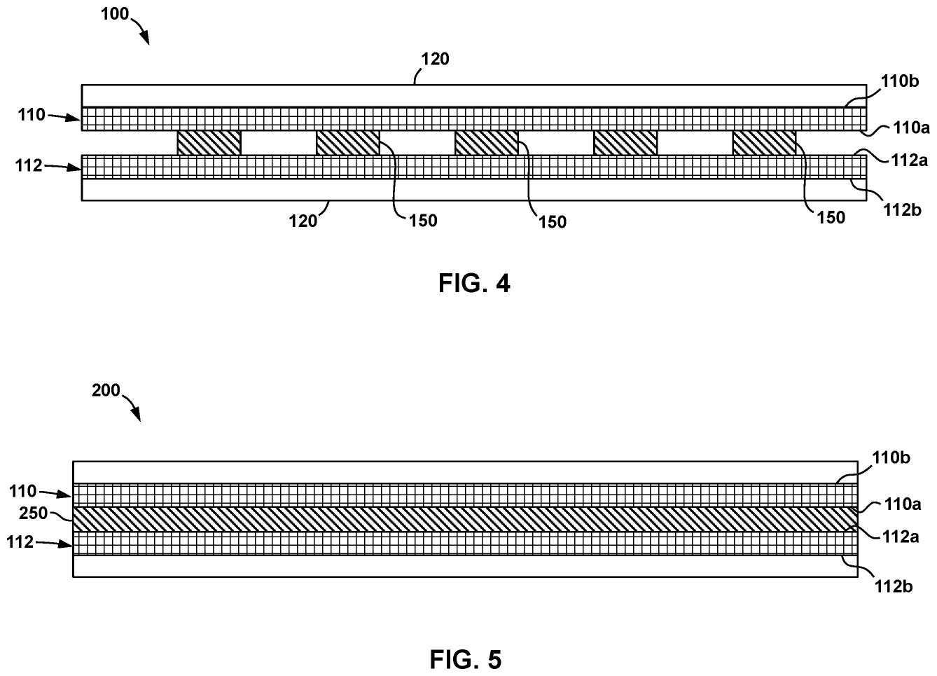

Referring now to FIG. 4, an example of first privacy panel 100 is shown. In particular, first privacy panel 100 includes a pair of electrodes 110, 112, and a first set of parallel lines 150 disposed between the electrodes 110, 112.

Electrodes 110, 112 each comprise a sheet or layer (or multiple sheets or layers) of conductive materials that are to conduct electrical current therethrough during operations. In some examples, electrodes 110, 112 are transparent or nearly transparent so that the images or information projected by the corresponding display (e.g., display 18) are not blocked or obstructed by electrodes 110, 112. In some examples, the electrodes 110, 112 may comprise an indium-tin-oxide; however, other materials are contemplated herein for electrodes 110, 112 in other examples.

Electrodes 110, 112 each include a first or inner side 110a, 112a, respectively, and a second or outer side 110b, 112b, respectively, opposite inner sides 110a, 112a, respectively. Electrodes 110, 112 are disposed within privacy panel 100 so that inner sides 110a, 112a face one another, and outer sides 110b, 112b face away from one another. The first set of parallel lines 150 are disposed between the inner sides 110a, 112a of electrodes 110, 112. During operations, electric current is provided to electrodes 110, 112 so that a differential voltage is generated between inner sides 110a, 112a. In some examples, electrodes 110, 112 uniformly or evenly conduct electrical current therethrough, so that the differential voltage between inner sides 110a, 112a of electrodes 110, 112, respectively, is the same (or substantially the same) at all locations along the inner sides 110a, 112a. As a result, electrodes 110, 112 may be referred to as “common electrodes.”

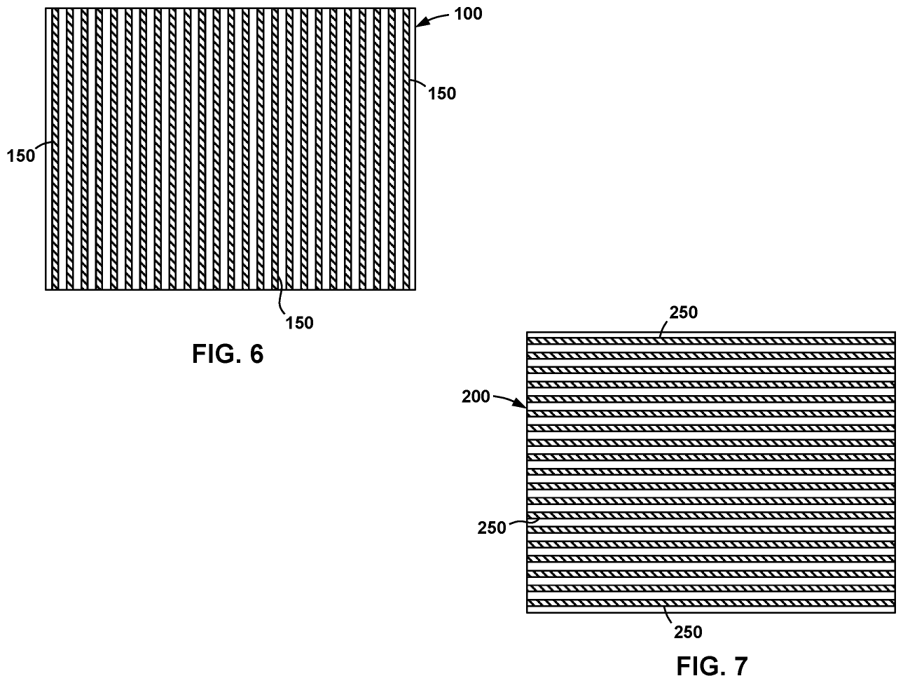

Referring now to FIGS. 4 and 6, the first set of (or plurality of) parallel lines 150 comprise materials that are to transition between transparent and non-transparent states when exposed to a differential voltage (e.g., such as the differential voltage generated by electrodes 110, 112). In particular, the first set of parallel lines 150 may be in a transparent state, whereby light is able to pass therethrough without being substantially affected (e.g., dimmed, scattered, etc.), when not exposed to a differential voltage (or a sufficient differential voltage). On the other hand, when the first set of parallel lines 150 is exposed to a sufficient differential voltage, the lines 150 are transitioned to a non-transparent state whereby light is dimmed or scattered by lines 150 or whereby light is prevented from passing through lines 150 entirely (i.e., lines 150 may be completely opaque in the non-transparent state). As shown in FIGS. 4 and 6, lines 150 are spaced from one another so that regardless of whether the lines 150 are in the transparent or non-transparent states, light may pass through the spaces between adjacent lines 150.

The first set of parallel lines 150 may comprise any suitable material that may be transitioned or actuated between transparent and non-transparent states as previously described above. For example, the first set of parallel lines 150 may comprise polymer dispersed liquid crystal (PDLC) in some instances. More particularly, PDLC comprises liquid crystal droplets that are dispersed within a polymer matrix. Liquid crystal molecules may be generally elongated in shape, and may change their orientation based on a surrounding magnetic or electric field (e.g., such as a differential voltage generated within an electric field). Thus, the orientation of liquid crystal molecules may be selectively changed when exposed to an applied differential voltage. During operations, an applied differential voltage (e.g., such as a differential voltage applied by electrodes 110, 112) causes the dispersed liquid crystals to reorient within the polymer matrix thereby altering their refractive index. As a result, the lines 150 appear opaque or partially opaque as described above.

In still other instances, the first set of parallel lines 150 may comprise an electrochromic material that is to selectively appear opaque or partially opaque upon the application of a sufficient differential voltage. In some examples, the electrochromic materials comprise materials that change color when a differential voltage is applied thereto. In some examples, the electrochromic materials may comprise inorganic materials, organic materials, or a mixture thereof. Examples of inorganic materials include metal oxides, such as tungsten oxide (WO₃), nickel oxide (NiO), etc. Examples of organic materials include viologens, polypyrrole, PEDOT, polyaniline, etc.

Referring specifically to FIG. 4, in some examples, first privacy panel 100 may also include a pair of transparent substrate layers 120 that are disposed on either side of the electrodes 110, 112. In particular, first privacy panel 100 may include one transparent substrate 120 disposed on outer side 110b of first electrode 110, and another transparent substrate 120 on outer side 112b of second electrode 112. Transparent substrates 120 may comprise any suitable transparent material, such as, for example glass, a polymer, etc.

Referring now to FIGS. 5 and 7, an example of second privacy panel 200 is shown. Second privacy panel 200 includes many components that are the same as those described above for first privacy panel 100, and thus, such components of second privacy panel 200 are identified with the same reference numerals as previously described above with respect to first privacy panel 100. In particular, second privacy panel 200 includes a pair of electrodes 110, 112 having inner sides 110a, 112a, respectively, and outer sides 110b, 112b, respectively, as previously described above. In addition, in this example, second privacy panel 200 includes a pair of substrates 120 disposed on outer sides 110b, 112b of electrodes 110, 112, respectively.

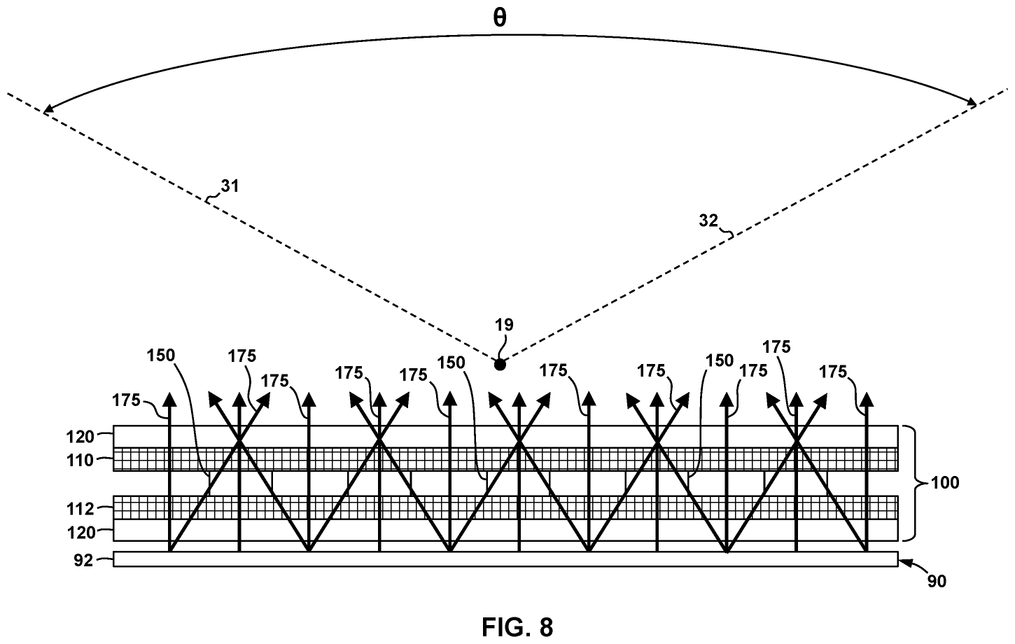

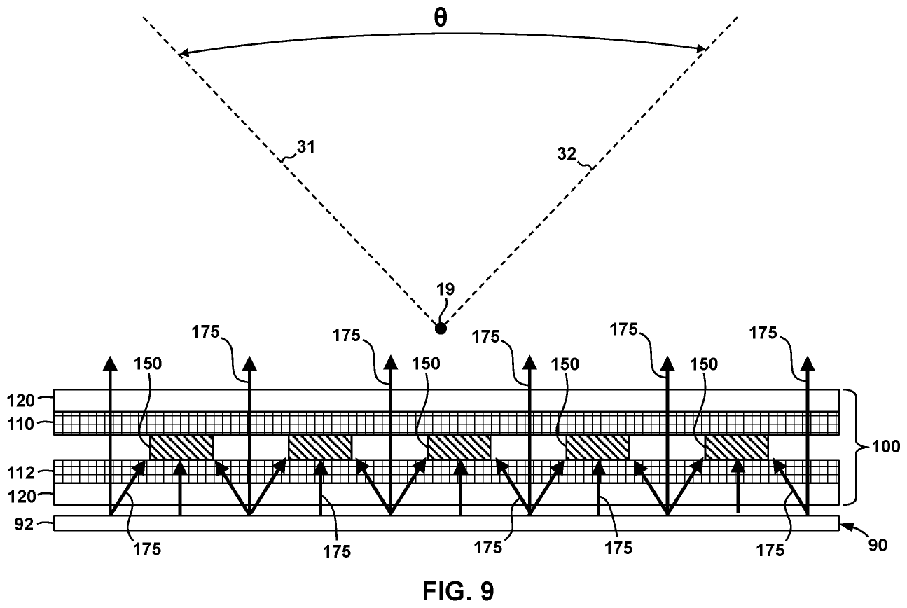

Still further, second privacy panel 200 includes a second set of parallel lines 250 that are generally the same as parallel lines 150 described above for first privacy panel 100, with the exception that the second set of parallel lines 250 are oriented perpendicularly to the first set of parallel lines 150 (see FIGS. 6 and 7). In particular, referring specifically to FIGS. 8 and 9, the first set of parallel lines 150 of first privacy panel 100 each extend in a first direction, whereas the second set of parallel lines 250 of the second privacy panel 200 extend in a second direction that is perpendicular to the first direction of the first set of parallel lines 150.

Referring still to FIGS. 6 and 7, while not specifically shown, the spaces between lines 150, 250 within privacy panels 100, 200, respectively, may be filled with a transparent material, such as, for example, a polymer, glass, etc. In still other examples, the lines 150, 250 may be embedded or encased within a corresponding transparent substrate that is disposed between inner sides 110a, 112a of electrodes 110, 112 within the corresponding panel 100, 200, respectively.

Referring now to FIG. 8, operations with first privacy panel 100 are described below, it being understood that the operations with second privacy panel 200 are substantially the same (except as specifically described herein). To ensure the simplicity and brevity of the drawings and description, FIG. 8 depicts shows first privacy panel 100 disposed atop backlight 90, and omits second privacy panel 200 and image generator 70 from FIG. 3; however, it should be appreciated that image generator 70 and second privacy panel 200 may be disposed within display 18 in the manner shown in FIG. 3 during operations.

Initially, the first set of parallel lines 150 within first privacy panel 100 may be in a transparent state such that light may pass freely therethrough (e.g., light emitted by backlight 90 may pass through panel 100, including the first set of parallel lines 150 substantially unaffected). As a result, substantially all of the light rays 175 emitted from light source 92 of backlight 90 are passed through first privacy panel 100, and viewing angle θ (previously described) is set at a first, relatively large value. Accordingly, when the first set of parallel lines 150 within first privacy panel 100 are in the transparent state as shown in FIG. 8, the image projected by display 18 may be viewed from relatively extreme angles within a first plane (e.g., the lateral plane defined by axes 15, 31, 32 in FIG. 1).

Referring now to FIG. 9, when it becomes desirable to limit or reduce the viewing angle of the display 18, so as to prevent individuals disposed adjacent to the display 18 from seeing the contents projected thereby, electrical current may be supplied to the electrodes 110, 112 to induce a differential voltage therebetween. As previously described above, the differential voltage between electrodes 110, 112 causes the first set of parallel lines 150 to transition from the transparent state shown in FIG. 8 to a non-transparent state shown in FIG. 9. When in the non-transparent state of FIG. 9, some of the light rays 175 emitted from light source 92 of backlight 90 are blocked, dimmed, or scattered by lines 150 so that viewing positions disposed at relatively large angles to the display 18 are unable to see or discern the images projected thereby. In particular, when the first set of parallel lines 150 are transitioned to the non-transparent state of FIG. 9, the viewing angle θ is reduced from the first, relatively large value shown in FIG. 8, to a second, relatively smaller value. Accordingly, when the first set of transparent lines 150 within first privacy panel 100 are in the non-transparent state as shown in FIG. 9, the image projected by display 18 may be viewed from positions that are generally disposed in front of the display 18 and not from positions that are disposed at relatively extreme angles within first plane (e.g., the lateral plane defined by axes 15, 31, 32 in FIG. 1).

Referring briefly to FIGS. 2 and 5, operations with second privacy panel 200 are substantially the same as those described above for first privacy panel 100, except that when electrodes 110, 112 within second privacy panel 200 are energized to induce a differential voltage therebetween, the second set of parallel lines 250 selectively adjust (e.g., reduce) the viewing angle β rather than the viewing angle θ. Accordingly, actuation of the first set of parallel lines 150 in the first privacy panel 100 is to selectively adjust the viewing angle θ in a first plane (e.g., the plane defined by axes 15, 31, 32 in FIG. 1) and actuation of the second set of parallel lines 250 in the second privacy panel 200 is to selectively adjust the viewing angle β in a second plane that is perpendicular to the first plane (e.g., the plane defined by axes 15, 33, 34 in FIG. 2).

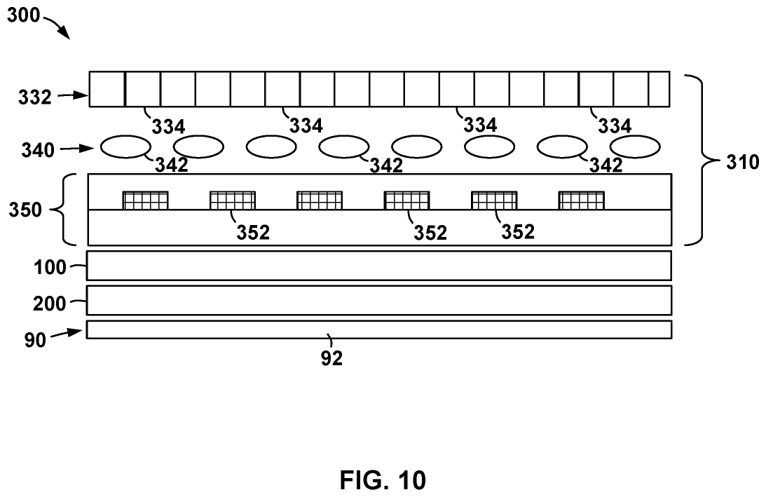

Referring now to FIG. 10, another example of a display 300 for use within electronic device 10 (see FIGS. 1 and 2) is shown. Display 300 includes privacy panels 100, 200, backlight 90, and an image generator 310, where privacy panels 100, 200 and backlight 90 are as previously described above. In this example, image generator 310 comprises a liquid crystal display panel that includes a color filter 332, a liquid crystal layer 340, and a thin-film transistor 350.

Generally speaking, thin film transistor 350 includes a plurality of pixel electrodes 352 organized in a series of rows and columns across a surface area of display 300. Each pixel electrode 352 may be selectively energized with electric current so as to induce a local electric field that applies a differential voltage to nearby objects or components. Thin film transistor 350 may include a plurality of other components (e.g., common electrode(s), polarizer(s), substrate(s), etc.); however, these additional features are not shown in FIG. 12 in the interest of brevity.

Liquid crystal layer 340 includes a plurality of liquid crystal molecules 342. During operations, the differential voltages generated by the local electric fields of selectively energized pixel electrodes 352 cause liquid crystal molecules 342 within liquid crystal layer 340 to assume predetermined orientations. For example, in some instances, when select pixel electrodes 352 are energized, the liquid crystal molecules 342 that are proximate the energized pixel electrodes 352 are oriented so as to allow light to pass through liquid crystal layer at preselected brightness levels. The electrical current provided to the select pixel electrodes 352 may be varied in order to cause a corresponding change in the orientation of the local liquid crystal molecules 342. As a result, an image may be formed by selectively altering the contrast of light that passes through the liquid crystal layer 340.

Referring still to FIG. 10, light that passes through the liquid crystal layer 340 is then directed across color filter 332. Color filter 332 includes a plurality of color filter cells 334 that are each to filter to a specific color of light. For instance, in this example, cells 334 include a repeating pattern of red, blue, and green color filter cells. A grouping of adjacent red, blue, and green color filter cells 334 may be referred to as a pixel—and thus, within each such pixel, the red, blue, and green color filter cells 334 may be referred to as “sub-pixels.” Without being limited to this or any other theory, the color filter cells 334 are to allow light of the corresponding color to pass through and to absorb light of different colors. Thus, the blue color filter cells 334 allow blue colored light to pass through, while absorbing light of other shades. Thus, each red, green, and blue color filter cell 334 may emit red, green, and blue colored light, respectively, and combinations of light from the red, green, and blue color filter cells 334 may be combined to create a multitude of other colors and shades.

During operations, the image forming light emitted from liquid crystal layer 340 is passed through color filter 332 so that the black and white image generated by liquid crystal layer 340 may be transformed into a color image. Specifically, while not specifically shown in the schematic representation of FIG. 12, the color filter cells 334 are generally aligned with the pixel electrodes 352 within thin film transistor 350. As a result, during operations, pixels electrodes 352 may be energized such that light is allowed to pass through selective color filter cells 334 in selective amounts so that the image generated thereby includes both contrast and color.

Referring still to FIG. 10, light that is emitted from light source 92 toward image generator is first passed through privacy panels 100, 200. The privacy panels 100, 200 may selectively adjust (e.g., limit or reduce) the viewing angle of the display 300 in first and second perpendicular planes, respectively, as previously described (such as in lateral and vertical planes, etc.). Thus, these specific operations are not described again in the context of display 300 in the interest of brevity.

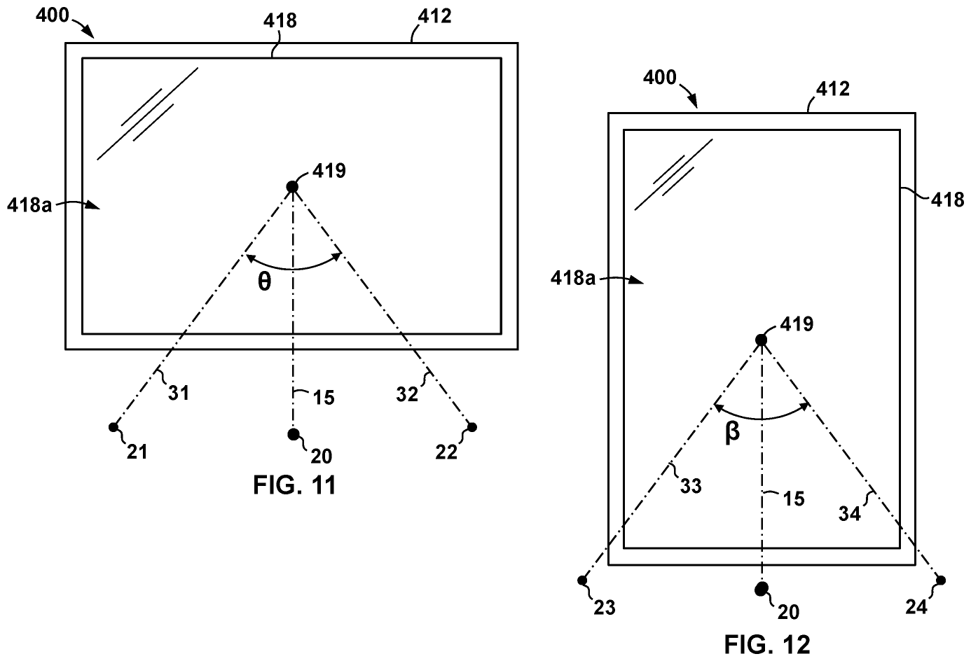

Referring now to FIGS. 11-13, another electronic device 400 according to some examples is shown. In this example, electronic device 400 is a tablet computer that includes a housing 412 that supports an electronic display 418. Display 418 may include the same or similar components as the displays 18, 300 previously described above (see FIGS. 1-10), and is therefore to project images out of a front side 418a for viewing by a user (not shown) of the electronic device 400. In addition, display 418 has first viewing angle θ that extends within a first plane defined by axes 31, 32 from a center 419 of display 418 and a second viewing angle β that extends within a second, perpendicular plane defined by axes 33, 34 from center 419 as previously described above for electronic device 10.

During operations, a user may typically hold or grasp housing 412 so that display 418 may be viewable in a number of different orientations or positions. Specifically, a user may view the display 418 in a first orientation shown in FIG. 11 and a second orientation shown in FIG. 12 that is rotated 90° from the first orientation of FIG. 11. In this example, the first orientation of FIG. 11 may be referred to as a landscape viewing orientation, and the second orientation of FIG. 12 may be referred to as a portrait viewing orientation. Therefore, in the context of display 418, the first viewing angle θ may represent the lateral viewing angle of display 418, when display 418 is in the landscape viewing orientation of FIG. 11, and the second viewing angle β may represent the lateral viewing angle of display 418 when display 418 is in the portrait viewing orientation of FIG. 12.

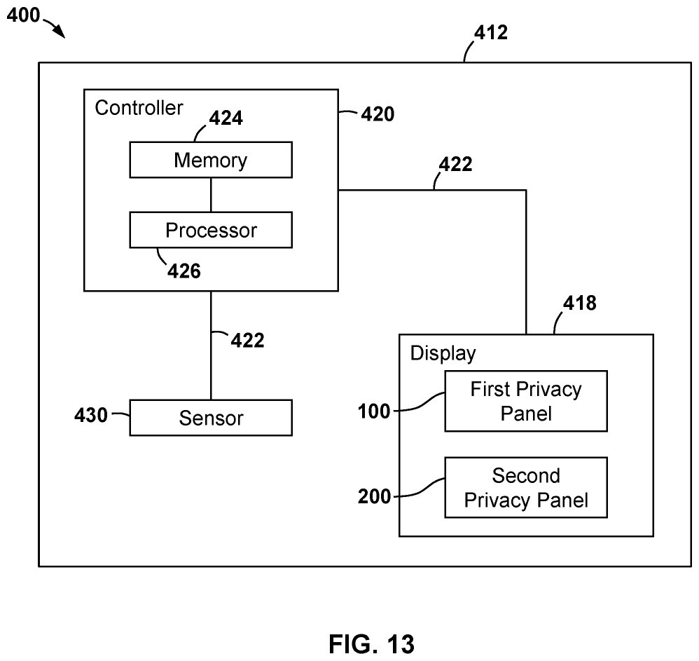

As previously indicated above display 418 may include privacy panels 100, 200 previously described above (see FIG. 13). Thus, during operations, the viewing angles θ, β may be selectively adjusted (e.g., limited, reduced, etc.) by energizing the electrodes 110, 112 of privacy panels 100, 200, respectively, and transitioning the sets of parallel lines 150, 250, respectively, from the transparent state to the non-transparent state in the manner previously described above (see e.g., FIG. 3). In addition, since a user may view display 418 in either a landscape orientation (see e.g., FIG. 11) or a portrait orientation (see e.g., FIG. 12), the privacy panels 100, 200 may be selectively actuated to provide privacy from laterally adjacent viewing positions for either viewing orientation.

Referring specifically now to FIG. 13, in addition to housing 412 and display 418, electronic device 400 includes a sensor 430 to sense or detect an orientation of the housing 412 and thus also the display 418 (e.g., such as whether display 418 in the landscape or portrait orientations of FIGS. 11 and 12, respectively), and a controller 420 coupled to the display 418 and sensor 430.

Sensor 430 may comprise any sensor or sensor(s) (e.g., a sensor array) that is to determine the angular position of display 418 of electronic device 400 during operations. For example, in some implementations sensor 430 includes an accelerometer (or a plurality of accelerometers) that is to measure the direction of the force of gravity relative to a known component (or multiple components) of electronic device 400. Thus, the output from sensor 430 may be utilized by controller 420 to determine the orientation of display 418—specifically whether display 418 is in a landscape orientation (e.g., as shown in FIG. 11) or a portrait orientation (e.g., as shown in FIG. 12).

Controller 420 is coupled to display 418 (particularly to privacy panels 100, 200 within display 418) and sensor 430. Generally speaking, controller 420 receives signals from sensor 430, and selectively actuates privacy panels 100, 200 (e.g., by energizing electrodes 110,112 within privacy panels 100, 200 as previously described—see FIGS. 3-5) to selectively provide lateral privacy for display 418 depending on the orientation a user is viewing display 418 in (e.g., landscape or portrait). Controller 420 may be a dedicated controller for operating privacy panels 100, 200 or may be included within a central controller or control assembly for electronic device 400. In this example, controller 420 is a dedicated controller for operating privacy panels 100, 200 and is able to communicate with other controllers or control assemblies within electronic device 400. The specific components and functions of controller 420 will now be described in detail below.

In particular, controller 420 may comprise any suitable device or assembly which is capable of receiving an electrical or mechanical signal and transmitting various signals to other devices (e.g., sensor 430, privacy panels 100, 200, etc.). In particular, as shown in FIG. 13, in this example, controller 420 includes a processor 426 and a memory 424.

The processor 426 (e.g., microprocessor, central processing unit, or collection of such processor devices, etc.) executes machine-readable instructions (e.g., non-transitory machine readable medium) provided on memory 424, and upon executing the machine-readable instructions on memory 424 provides the controller 420 with all of the functionality described herein. The memory 424 may comprise volatile storage (e.g., random access memory), non-volatile storage (e.g., flash storage, read only memory, etc.), or combinations of both volatile and non-volatile storage. Data consumed or produced by the machine-readable instructions can also be stored on memory 424.

Controller 420 is coupled or linked to sensor 430 and display 418 by a plurality of conductive paths 422, which may comprise any suitable wired and/or wireless conductive path for transferring power and/or control signals (e.g., electrical signals, light signals, etc.). For example, in some implementations, conductive paths 422 may comprise conductive wires (e.g., metallic wires), fiber optic cables, conductive leads, etc. In other implementations, conductive paths 422 may comprise wireless connections (e.g., WIFI, BLUETOOTH®, near field communication, infrared, radio frequency communication, etc.).

During operations, controller 420 receives an output signal from sensor 430. The output from sensor 430 may provide the orientation of housing 412 of electronic device 400 or may include an indication of the orientation of housing 412. As a result, in some examples, controller 420 may determine (e.g., via processor 424 executing machine readable instructions stored in memory 426) whether the display 418 is in a landscape or a portrait orientation (e.g., see FIG. 11 or 12, respectively) based entirely or in part on the output signal from sensor 430.

Once controller 420 determines the orientation of display 418, controller 420 may then actuate one of the privacy panels 100, 200 to provide lateral privacy based on their determined orientation. Specifically, if controller 420 determines that display 418 is in the landscape orientation of FIG. 11, via an output signal from sensor 430, controller 420 may then actuate the first privacy panel 100 to adjust (e.g., reduce, limit, etc.) the viewing angle θ (e.g., in the manner previously described above) and thereby provide enhanced privacy from viewing positions disposed laterally adjacent the display 418 (e.g., unauthorized viewers disposed to the side of the primary user of the electronic device 400). Conversely, if controller 420 determines that display 418 is in the portrait orientation of FIG. 12, via an output signal from sensor 430, controller 420 may then actuate the second privacy panel 200 to adjust (e.g., reduce, limit, etc.) the viewing angle β (e.g., in the manner previously described above) and thereby provide enhanced privacy from viewing positions disposed laterally adjacent the display 418 (e.g., unauthorized viewers disposed to the side of the primary user of the electronic device 400).

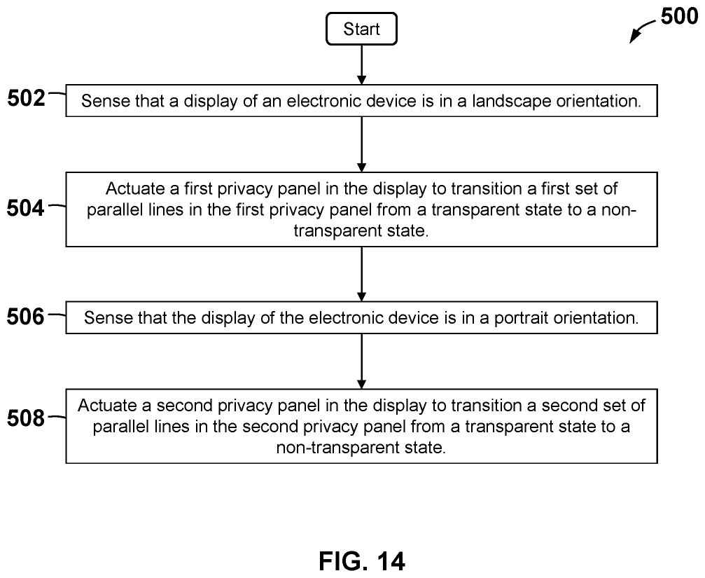

Referring now to FIG. 14, a method 500 for providing selective privacy for an electronic display in either a portrait or landscape orientation is shown. In describing the steps of method 500, reference will be made to electronic device 400 shown in FIGS. 11-13; however, it should be appreciated that method 500 may be practiced with other electronic devices, and the reference to electronic device 400 and its components is not mean to limit the application of method 500.

Initially, method 500 includes sensing that a display of an electronic device is in a landscape orientation at 502. For example, for the electronic device 400 of FIGS. 11-13, the controller 420 may determine the orientation of display 418 by receiving and/or interpreting the output signal from sensor 430. Next, referring still to FIG. 14, method 500 includes actuating a first privacy panel in a display of the electronic device to transition a first set of parallel lines in the first privacy panel from a transparent state to a non-transparent state at 504. For example, for the electronic device 400 in FIGS. 11-13, controller 420 actuates a first privacy panel 100 by energizing electrodes disposed therein (e.g., electrodes 110, 112 shown in FIG. 4) to transition a first set of parallel lines (e.g., parallel lines 150 shown in FIG. 4) within first privacy panel 100 from a transparent state to a non-transparent state. In some examples, the actuation of the first privacy panel at 504 may occur as a result of the sensing the display in the landscape orientation at 502.

Referring still to FIG. 14, method 500 next includes sensing that the display of the electronic device is in a portrait orientation at 506. For example, for the electronic device 400 of FIGS. 11-13, the controller 420 may again determine the orientation of display 418 by receiving and/or interpreting the output signal from sensor 430. Finally, method 500 includes actuating a second privacy panel in the display to transition a second set of parallel lines in the second privacy panel from a transparent state to a non-transparent state at 508. For example, for the electronic device 400 if FIGS. 11-13, controller 420 actuates a second privacy panel 200 by energizing electrodes disposed therein (e.g., electrodes 110, 112 shown in FIG. 4) to transition a second set of parallel lines (e.g., parallel lines 250 shown in FIG. 4) within first privacy panel 200 from a transparent state to a non-transparent state. In some examples, the actuation of the second privacy panel at 508 may occur as a result of the sensing of the display in the portrait orientation at 502. In addition, in some examples, the second set of parallel lines in the second privacy panel at 508 may be perpendicular to the first set of parallel lines in the first privacy panel at 504.

Therefore, through use of the privacy panels (e.g., privacy panels 100, 200) and the displays incorporating the same (e.g., displays 18, 300, 418), a user may more adequately protect sensitive or confidential images projected by the display by selectively limiting the visible viewing angle(s) of a display during operations. In addition, a user may also selectively limit the lateral viewing angle of the display regardless of the orientation that display may be disposed in (e.g., landscape or portrait viewing orientations shown in FIGS. 11 and 12) by selectively actuating one of a pair of privacy panels as previously described above.

While the above discussed displays and privacy panels (e.g., displays 18, 300, 418, and privacy panels 100, 200) have been described for use within laptop computing device 10 shown in FIGS. 1 and 2 and a tablet computing device 400 shown in FIGS. 11 and 12, it should be appreciated that the displays and privacy panels described herein may also be included in any other device or assembly that includes or incorporates an electronic display. For example, the above described displays and/or privacy panels may be included in computer monitors, televisions, smartphones, tablet computers, electronic picture frames, etc.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An electronic device comprising:
a housing; and
a display coupled to the housing, wherein the display comprises:
a backlight;
an image generator to form an image from light emitted from the backlight;
a first privacy panel comprising a first set of parallel lines; and
a second privacy panel comprising a second set of parallel lines that are perpendicular to the first set of parallel lines;
wherein the first privacy panel and the second privacy panel are disposed between the image generator and the backlight;
wherein the first set of parallel lines is to actuate to selectively adjust a first viewing angle of the display in a first plane; and
wherein the second set of parallel lines is to actuate to selectively adjust a second viewing angle of the display in a second plane that is perpendicular to the first plane.

2. The electronic device of claim 1, wherein the first set of parallel lines are disposed between a first pair of electrodes within the first privacy panel, and wherein the second set of parallel lines are disposed between a second pair of electrodes within the second privacy panel.

3. The electronic device of claim 2, wherein the first pair of electrodes is to selectively induce a first differential voltage to actuate the first set of parallel lines between a transparent state and non-transparent state, and wherein the second pair of electrodes is to selectively induce a second differential voltage to actuate the second set of parallel lines between a transparent state and a non-transparent state.

4. The electronic device of claim 3, wherein the first set of parallel lines and the second set of parallel lines comprise polymer dispersed liquid crystal (PDLC).

5. The electronic device of claim 3, wherein the first set of parallel lines and the second set of parallel lines comprise an electrochromic material.

6. The electronic device of claim 3, comprising:
a sensor disposed within the housing to sense whether the display is in a first orientation or a second orientation, wherein the second orientation is rotated 90° from the first orientation; and
a controller disposed within the housing and coupled to the sensor, the first privacy panel, and the second privacy panel, wherein the controller is to:
actuate the first set of parallel lines to the non-transparent state and actuate the second set of parallel lines to the transparent state when the sensor senses that the display is in the first orientation; and
actuate the second set of parallel lines to the non-transparent state and actuate the first set of parallel lines to the transparent state when the sensor senses that the display is in the second orientation.

7. An electronic device comprising:
a housing; and
a display coupled to the housing, wherein the display comprises:
a backlight;
an image generator to form an image from light emitted from the backlight;
a first privacy panel comprising a first set of parallel lines;
a second privacy panel comprising a second set of parallel lines that are perpendicular to the first set of parallel lines;
wherein the first privacy panel and the second privacy panel are disposed between the image generator and the backlight,
a sensor to sense whether the display is in a first orientation or a second orientation, wherein the second orientation is rotated 90° from the first orientation;
a controller coupled to the sensor, the first privacy panel, and the second privacy panel, wherein the controller is to:
actuate the first set of parallel lines to a non-transparent state and actuate the second set of parallel lines to a transparent state when the sensor senses that the display is in the first orientation; and
actuate the second set of parallel lines to a non-transparent state and actuate the first set of parallel lines to a transparent state when the sensor senses that the display is in the second orientation.

8. The electronic device of claim 7, wherein the first set of parallel lines and the second set of parallel lines comprise polymer dispersed liquid crystal (PDLC).

9. The electronic device of claim 7, wherein the first set of parallel lines and the second set of parallel lines comprise an electrochromic material.

10. The electronic device of claim 7, wherein the first set of parallel lines are disposed between a first pair of electrodes within the first privacy panel, and wherein the second set of parallel lines are disposed between a second pair of electrodes within the second privacy panel.

11. The electronic device of claim 10, wherein the controller is to actuate the first pair of electrodes to induce a first differential voltage to actuate the first set of parallel lines from the transparent state to the non-transparent state; and
wherein the controller is to actuate the second pair of electrodes to induce a second differential voltage to actuate the second set of parallel lines from the transparent state to the non-transparent state.

12. The electronic device of claim 11, wherein the image generator comprises liquid crystal image generator.

13. An electronic device comprising:
a housing; and
a display coupled to the housing, wherein the display comprises:
a backlight;
an image generator to form an image from light emitted from the backlight;
a first privacy panel comprising:
a first pair of electrodes; and
a first set of parallel lines disposed between the first pair of electrodes; and
a second privacy panel comprising:
a second pair of electrodes; and
a second set of parallel lines disposed between the second pair of electrodes, wherein the second set of parallel lines are perpendicular to the first set of parallel lines;
wherein the first privacy panel and the second privacy panel are disposed between the image generator and the backlight;
wherein the first pair of electrodes are to selectively induce a first differential voltage to actuate the first set of parallel lines from a transparent state to a non-transparent state; and
wherein the second pair of electrodes are to selectively induce a second differential voltage to actuate the second set of parallel lines from a transparent state to a non-transparent state.

14. The electronic device of claim 13, wherein the first set of parallel lines and the second set of parallel lines comprise polymer dispersed liquid crystal (PDLC).

15. The electronic device of claim 13, wherein the first set of parallel lines and the second set of parallel lines comprise an electrochromic material.
